(19) United States
(12) Patent Application Publication
(10) Pub. No.: US 2009/0090676 A1
(43) Pub. Date: Apr. 9, 2009

(54) Method of Distributing Desalination Functions While Reducing the Environmental Impact of Industrial Cooling Water and the Introduction of Brine to Brackish or Saline Water Sources

(75) Inventor: Leonard Johnson, Fullerton, CA (US)

Correspondence Address: KIRK HAHN, 14431 HOLT AVE, SANTA ANA, CA, 92705, US

(73) Assignee: THH, Inc., Chino, CA (US)

(21) Appl. No.: 11/866,958

(22) Filed: Oct. 3, 2007

(51) Int. Cl. C02F 1/58; H02K 7/18

(52) U.S. Cl. 210/747; 210/767; 210/774; 290/52

(57) ABSTRACT

An economical and environmentally responsible method of desalination and delivery of freshwater, concentrate, and electrical power to a site removed from the saline water source. Freshwater, concentrate, and power can be delivered by pipeline to multiple locations along the route and/or at the endpoint, thus distributing the beneficial aspects while minimizing the environmental impact of desalination facilities.

### BACKGROUND

1. Field of Invention

This invention relates generally to methods of providing desalinated water.

2. Related Art

Water, its location and abundance, is critical in determining where people will live. Water is needed for all the basic requirements of life—drinking; growing crops; commerce and industry; construction; landscaping; feeding domestic animals; and dozens of other purposes. It is so important that rivers have been dammed, aqueducts built to transport it from distant locations and wars fought to protect its continued ownership.

There are many arid and semi-arid areas in the World where there are ever increasing needs for usable water as the existing sources slowly decrease in abundance. Additionally, vast areas of usable land remain barren due to a lack of water.

The real problem is not a lack of water, since the Earth is covered by vast Oceans of water, large river systems, and polar ice caps, but a lack of water in regions where water is naturally not present in great abundance. The Earth's growing population requires more land for human occupation and more land to produce food to support that population. Water is needed to make the land useable by Man. Water is needed for drinking, crop irrigation, disposal of waste, and numerous other uses.

As the Human population in the World continues to increase, more and more radical plans are devised to obtain water. Rivers in the Northern latitudes are envisioned being re-directed by large pipes to transport the “wasted” water in wild rivers to populated areas in the South. Icebergs in the Artic and Antarctic are pictured being towed towards large cities to supply drinking water. The seawater in the Oceans is seen as an almost unlimited source of freshwater.

The most common method to solve the lack of water in places of need is to transport the water from areas of abundance to areas in need of the water. This solution is satisfactory until the demand for water eventually exceeds the ability to supply the water from these sites of abundance. As farther and farther sources of water are tapped for use by the growing populations, the cost of transporting the water and the degradation of the environment becomes so large that it ceases to be economical to supply water by this method.

At a “tipping point”, the cost of transporting fresh water becomes so expensive that it becomes economically feasible to extract usable water from the unusable saline water in the Oceans surrounding the continents.

Most current plans for obtaining abundant sources of freshwater are technologically possible but economically unfeasible. Currently, the only proposed “Big” plan that is reaching economic feasibility is Desalination of saline bodies of water. Desalination refers to any of several processes that remove excess salt and other minerals from water in order to obtain fresh water suitable for animal consumption, irrigation, industry, or human consumption. Desalination offers the ability to produce usable water at a reasonable cost, even though it is currently still too expensive in almost all situations except where the need is so great that cost is not the principal factor.

The first commonly used desalination method was distillation of seawater to produce fresh water. This method was very energy intensive so the cost of large-scale desalination production was impractical. Distillation of seawater is so cost prohibitive that it is only used in rather extreme cases; e.g., naval vessels, off-shore oil rigs, and isolated island outposts.

A more economical method of desalination is Reverse Osmosis. In simple terms, fresh water is produced by pumping a saline solution at high pressure into a pressure vessel divided by a semi permeable membrane that allows H₂O to pass through the barrier while keeping most salutes on the other side of the barrier.

Osmosis is the natural process where water moves across a semi permeable membrane up a solution concentration gradient, from a less-concentrated solution (hypotonic) to a more-concentrated solution (hypertonic). This is accomplished without external energy sources, as the concentration of the solutions themselves drives the process. Indeed, energy is actually released during this process, and may drive other dependent processes in the natural world.

Reverse osmosis is the reverse of the natural process of osmosis, and is usually man-made. That is, a hypertonic solution is pressurized on one side of a semi-permeable membrane to between 350 and 2000 psi, forcing water through the membrane which acts as a very fine filter. A hypotonic solution is thus produced on the other side of the barrier. If pressure were removed, it is possible that osmosis would eventually return the two solutions to stasis.

Desalination with reverse osmosis requires a high pressure to be applied on the hypertonic side of the membrane, usually 2-17 bar (30-250 psi) for brackish water and 40-138 bar (600-2000 psi) for seawater. Sea water has around 24 bar (350 psi) of natural osmotic pressure which must be mechanically overcome to achieve reverse osmosis.

Currently, desalination is usually performed at or very near the source of inflow water. This includes pretreatment and initial filtration; pressurization; brine disposal; post-treatment of purified water; and re-pressurization for transport via pipeline. Reverse Osmosis facilities are often located in areas of fragile ecosystems or high population density, which causes problems due to the large volumes of brine which must be disposed of as well as the standard practice of introducing chemicals used to pre-treat inflow water, such as de-scaling additives, that are potentially harmful to the environment.

Crystallization of soluble salts may occur when either surface or ground water sources are used in membrane desalination processes such as Reverse Osmosis (RO). Concentrations of calcium, sulfate, bicarbonates and biological agents are usually present in natural sources of water. When attempting high recovery ratios (those exceeding 30%), at least some salts and organisms will be unable to transit the membrane. When salts exceed their saturation levels in the resulting brine, they begin to form crystals. The possible surface blockage of the membrane surface by this crystallization is known as ‘scaling’. In order to process water at a high recovery ratio, various chemicals (usually polymers) are added to source water. Some anti-scalants are specifically designed to be innocuous to the environment, while others may be extremely toxic. The selection of anti-scalants is application-specific based on source water composition and desired recovery ratio.

The Total Specific Water cost from a Collocated nuclear plant with Reverse Osmosis, and without transportation of fresh water or concentrate is $0.512 m³. However, the Specific Water cost from a Collocated nuclear plant and Reverse Osmosis, with conventional fresh water transportation via high pressure pipeline is $0.768 m³. This is still too high when compared with the cost of water from municipal sources which is often subsidized by government. Municipal water in Southern California is around $0.19/m³ for home use and $0.03/m³ for agricultural use. Reverse Osmosis shows promise as a method to obtain usable water, but the cost must be reduced to make it an economical alternative to current water supply methods.

The energy requirements of desalination reverse osmosis plants are large, but electricity can be produced relatively cheaply in areas with abundant oil reserves (e.g., Middle East). The desalination plants are often located adjacent to power plants.

There are circumstances in which it may be possible to use the same energy more than once. With cogeneration this occurs as energy drops from a high level of activity to an ambient level. Desalination processes, in particular, can be designed to take advantage of co-generation. For example, dual-purpose facilities can produce both electricity and water. The main advantage is that a combined facility can consume less net energy than would be needed by two separate facilities. This may be accomplished by two steps: using the heat energy normally carried away by cooling water in desalination, and reclaiming the power used to pump and pressurize water.

Reverse osmosis desalination is much more efficient when warmer water is used, with efficiency peaking at about 90° F., which is the regulatory limit in some areas on cooling water output temperature when exhausted into the sea by an industrial facility.

Power recovery at the output stage of desalination, the second way of saving energy, is made possible by the fact that reverse osmosis typically only consumes 2 to 3 bars of the input pressure. This means the output may remain in excess of 67 bars. Transformation of this potential energy into mechanical output can be accomplished by a Pelton wheel.

A Pelton wheel is one of the most efficient types of water turbines. It is an impulse machine that uses Newton's second law to extract energy from a jet of fluid. The pelton wheel turbine is a tangential flow impulse turbine, water flows along the tangent to the path of the runner. Nozzles direct forceful streams of water against a series of spoon-shaped buckets mounted around the edge of a wheel. Each bucket reverses the flow of water, leaving it with diminished energy. The resulting impulse spins the turbine. The buckets are mounted in pairs, to keep the forces on the wheel balanced, as well as to ensure smooth, efficient momentum transfer of the fluid jet to the wheel.

Since water is not a compressible fluid, almost all of the available energy is extracted in the first stage of the turbine. Therefore, Pelton wheels have only one wheel, unlike turbines that operate with compressible fluids. Pelton wheels are best for high head, low flow situations. It is usually better to seek a large pressure using a large head rather than to go for a fast flow rate.

The output of the Pelton wheel may be used to mechanically drive the pumping mechanism that is used to pressurize the input saline stream for desalination, or to generate electrical power.

Power recovery ratios on the order of 88% or better are possible, greatly reducing the power requirement for the desalination process, for which pumping may consume as much as 85% of the total power required (not counting the energy required to heat input water, which in cogeneration is obtained for free.)

A number of factors determine the capital and operating costs for desalination: capacity and type of facility, location, feed water, labor, energy, financing and concentrate disposal. Desalination methods control pressure, temperature and brine concentrations to optimize the water extraction efficiency. Nuclear-powered desalination might be economical on a large scale.

Critics point to the high costs of desalination technologies, especially for poor third world countries, the impracticability and cost of transporting or piping massive amounts of desalinated seawater throughout the interiors of large countries, and the byproduct of concentrated seawater, which some environmentalists have claimed is a major cause of marine pollution when dumped back into the oceans.

A study on current desalination technology noted that the costs are falling and generally usable for affluent areas that are proximate to oceans, so it may be a solution for some water-stressed regions. However, it is not appropriate for places that are poor, deep in the interior of a continent, or at high elevation; which unfortunately includes places with the biggest water problems.

Large coastal urban cities in the developed countries are increasingly looking at the feasibility of seawater desalination, due to its cost effectiveness when compared with other water supply augmentation options.

One of the main environmental considerations of ocean water desalination plants is the impact of the open ocean water intakes, especially when co-located with power plants. Many proposed ocean desalination plants initial plans relied on these intakes despite perpetuating huge ongoing impacts on marine life. In the United States, due to a recent court ruling under the Clean Water Act these intakes are no longer viable without reducing mortality by ninety percent of the plankton, fish eggs and fish larvae in the ocean water.

Regardless of the method used, there is always a highly concentrated waste product consisting of everything that was removed from the extracted fresh water. This is sometimes referred to as brine, which is also a common term for the byproduct of recycled water schemes that is often disposed of in the ocean. These concentrates are classified by the U.S. Environmental Protection Agency as industrial wastes. Reverse osmosis, for instance, may require the disposal of wastewater with salinity several times that of normal seawater. The benthic community cannot accommodate such an extreme change in salinity and many filter-feeding animals are destroyed when the water is returned to the ocean. This may present a similar problem further inland, where one needs to avoid ruining existing fresh water supplies such as ponds, rivers and aquifers. As such, proper disposal of concentrate needs to be insured during the design phases.

Concentrated seawater has the potential to harm ecosystems, especially marine environments in regions with low turbidity and high evaporation that already have elevated salinity. Examples of such locations are the Persian Gulf, the Red Sea and, in particular, coral lagoons of atolls and other tropical islands around the world. Because the brine is denser than the surrounding sea water due to the higher solute concentration, the ecosystems on the sea bed are most at risk because the brine sinks and remains there long enough to damage the ecosystems. It is capable of settling into depressions in the sea bed which function as a bowl. Dilution only occurs in the region where ordinary sea water and the concentrate are directly in contact, so that the ratio of surface area to brine mass comes into play during dilution. The larger the continual mass of submerged concentrate, the less surface area there is in ratio to that mass, and the slower acceptable dilution occurs. It is surmised in some studies that discharges of concentrate attending the normal operation of very large desalination plants may continue to extend undiluted masses of hyper salinity along the bottom of a sea almost as long as the plant remains in operation.

The discharge of the salt concentrate from a desalination plant is harmful to the environment. The influx of freshwater causes an influx in population growth near the power plant. Reverse Osmosis requires a large amount of energy to drive the operation (˜3.5 to 4.5 KWH/m³) which accounts for $0.14 to $0.18 per m³ or $170 to $225 per acre-foot. The typical desalination plant transports only the treated fresh water from the plant, which requires high pressure pumping for both the desalination process and transporting the fresh water. This requires the duplication of both the energy and equipment. The brine is not transported from the facility, and is discharged locally into the sea. Power recovery at the outflow point of freshwater pipelines is not done, which means that the power required to pressurize the freshwater pipeline is effectively lost.

Current Reverse Osmosis facilities, even with power recovery features, fail because they waste power by pressurizing the water twice, once for Reverse Osmosis, and again for freshwater pipeline transport; do not transport brine that creates environmental problems by requiring local disposal; and do not attempt power recovery following pipeline transport.

### SUMMARY

The disclosed desalination method, associated arrangement of Reverse Osmosis modules, economic value of the resulting products, and energy recovery comprises an efficient process to desalinate brackish, salt, or otherwise contaminated water to produce usable water.

Disclosed is an economical and environmentally responsible method of desalination and delivery of freshwater, concentrate, and electrical power to a site removed from the saline water source. Freshwater, concentrate, and power can be delivered by pipeline to multiple locations along the route and/or at the endpoint, thus distributing the beneficial aspects while minimizing the environmental impact of desalination facilities.

The disclosed system transports both fresh water and concentrate while maintaining the thermal advantage of outflow cooling water from an industrial facility such as a power generation plant. In doing so, fresh water is delivered to regions in need of water and the concentrate arrives where it can be profitably processed or used rather than discarded, and without incurring additional power requirements for transportation because of the economic equation of a high-bulk, low-value commodity.

The disclosed method produces freshwater from a saline water source and delivers it economically a distance away from the power plant.

Another disclosed method is the economical transport of fresh water by recovering the power used to pressurize the pipe by using a Pelton wheel.

Another disclosed method is the use of excess water flow to clean the semi-permeable membrane used for reverse osmosis.

Other objects, features, embodiments and advantages of the present invention will become apparent from the following description when considered in connection with the accompanying figures. It is to be expressly understood, however, that each of the figures is provided for purpose of illustration and description only and is not intended as a definition of the limits of the present invention.

### BRIEF DESCRIPTION OF THE DRAWINGS

List of drawings

FIG. 1 is a schematic view of the overall scope of the disclosure.

FIG. 2 is a schematic view of a single reverse osmosis unit where a freshwater outflow is produced and the concentrate is returned to the water transportation line. This is an inline desalination unit.

FIG. 3 is a schematic view of a single reverse osmosis unit where a freshwater outflow is produced and the concentrate is passed through a pelton wheel before being used for a commercial purpose. This is a terminal desalination module.

FIG. 4 is a schematic view of multiple reverse osmosis units in series where final concentrate outflow is passed through a pelton wheel before being used for a commercial use. In this example, each R/O unit is designed to accept the flow, pressure, and salinity of the preceding unit. These are mainly inline desalination modules, but the final module could be a terminal desalination module.

FIG. 5 is a schematic view of a single reverse osmosis unit where the freshwater outflow, concentrate outflow, and electricity are delivered to same location.

### DETAILED DESCRIPTION

### Definitions

As used herein, agriculture water is water that meets the standards for agriculture use (either for irrigation or animals) and may not meet the standards for human consumption due to taste, composition, or both.

Anti-scalant—a chemical (usually a polymer) that is added to the source water used for reverse osmosis to either prolong the onset of crystallization by extending the solubility of salts that are most offensive in the water source, or minimize the tendency of the salt to cling to the membrane surface once crystallization occurs, thus allowing water flow to flush them out of the RO device.

Brackish water—0.05%-3% salinity.

Brine—>5% salinity

Brine disposal—long-term disposition of the high-salinity remainder following extraction of fresh water through membrane extraction, such as, reverse osmosis.

Caustics—base catalysts, such as, potassium hydroxide or sodium hydroxide, used to promote chemical reactions.

Cogeneration facility—a facility added to an existing industrial plant in order to produce a different product than the original plant produces. An example is a desalination facility that produces fresh water by accepting discharged heated cooling water from a nuclear power plant.

Collocated facility—a cogeneration facility that is physically located adjacent or immediately next to or even within another facility.

Concentrate—also called brine; >5% salinity.

Cooling towers—structures which are intended to facilitate evaporative cooling for an industrial facility.

Cooling Water (CW) system—water circulation system by which an industrial facility dissipates excess heat. There are two types: pass-through cooling, and evaporative cooling. Pass-through uses a nearby open water source as a heat sink, and passes through all of the excess heat by heating large amounts of intake water and discharging it back into the water source. Evaporative cooling utilizes cooling towers to dissipate at least some of the excess heat into the atmosphere.

Dechlorination chemicals—chemicals that counter or remove chlorine from water are called dechlorination chemicals.

Desalination—a process that converts seawater or brackish water to fresh water or an otherwise more usable condition through removal of dissolved solids; removing salts from ocean or brackish water by using various technologies; production of fresh water by removing salt from seawater or brackish water through the application of energy; or any of several processes that remove the excess salt and minerals from water in order to obtain fresh water suitable for animal consumption or for irrigation.

Desalination system—the equipment, pipes, pumps and other items combined to accomplish desalination.

Dispersant—an additive which keeps fine particles of insoluble materials in a homogeneous solution. Hence, particles are not permitted to settle out and accumulate.

Distillation—a process of heating water until it evaporates as steam leaving behind bacteria, minerals, trace amounts of metals, sodium chloride, organic chemicals and nitrate, and subsequently condensing the steam into water.

Electrical Grid—the electrical distribution network of any community.

Electrical Power Exchange—an electrical generation concern, retail electrical exchange, and/or wholesale electrical exchange who provides electrical power to itself or to one or more customers. It is not necessary for an Electrical Power Exchange to generate electricity in order to exchange it, so this term is intended to include any entity selling and/or contracting for electrical power.

Evaporation pond—a shallow pond designed to produce salt from sea water. The seawater is fed into large ponds and water is drawn out through natural evaporation which allows the salt to be subsequently harvested.

Fresh water—a general term for “sweet water”, agricultural (ag water), potable (drinking water), or to any other water that contains <0.5% salt and minerals, such as, most pond and lake water.

High Pressure Pump—a pump that has a working output pressure exceeding 1000 psi.

Hypersaline—water with a high concentration of salt, greater than the ionic content of seawater.

Hyper-saline agriculture water—ag water containing from 5% salts to saturation (˜27%).

Inline desalination module—a desalination unit that does not terminate the transportation system, but is either inserted into or fed by the water transportation pipeline.

MegaWatts electric (MWe)—one million watts of electric energy.

MegaWatts thermal (MWt)—one million watts of thermal (heat) energy.

Near saturation—a point at which liquid water will hold minerals in solution, but is within 7 percentage points of saturation.

Non-potable water—unsafe or unpalatable to drink because in contains objectionable pollution, contamination, minerals, or infective agents.

Offsite Location—a location that is not collocated [not close to or at the same place] with the Power plant.

Pelton wheel—also called a Pelton turbine, an efficient type of water turbine; an impulse machine (uses Newton's second law to extract energy from a jet of fluid).

Pipeline—a pressurized pipe through which bulk liquids are transported.

Potable water—clean and free from harmful chemicals and disease-carrying microbes.

Power recovery—process by which power that has been expended is subsequently recovered, usually to be directed elsewhere. An example is converting the energy required to pressurize water from the resulting high pressure stream to rotational energy by directing that stream to strike the blades of a Pelton wheel. The rotational energy thus obtained by power recovery may be used for another purpose, such as, turning an electrical generator or another water pump.

Pressurization—exerting force in order to create pressure in a fluid or gaseous medium. An example is creating water pressure within a piping system with a water pump.

Pre-treat inflow water—process of initial straining, coarse filtering, or the addition of chemicals to inflow water in order to facilitate it's use. An example is the inflow water in industrial cooling loops that utilize sea water may be pre-treated by sand-filtration to remove most organisms, and may additionally have chemicals added to reduce the tendency to foul pumps and fittings with mineral deposits. Another example is a Reverse Osmosis desalination facility may pre-treat inflow water with anti-scalants to delay the onset of organic and inorganic deposits blocking the membrane surfaces, which necessitates membrane maintenance and possible replacement.

Pre-treated seawater—inflow seawater that is pre-treated.

Pretreatment—process of treating water prior to introduction to a cooling or desalination facility.

Re-pressurization—increasing the water pressure, after the pressure loss during desalination, to the pressure within the pipeline so that the outflow can be returned to the pipeline transportation system.

Reverse Osmosis (RO)—a process whereby dissolved salts, such as sodium, chloride, calcium carbonate, and calcium sulfate may be separated from water by forcing the water through a semi-permeable membrane under high pressure. The water diffuses through the membrane and the dissolved salts remain in solution on the input side of the membrane.

RO desalination module—the combination of equipment, pumps, pipes, treatment processes and other items used to obtain saline water from the transportation pipe to produce freshwater and concentrate, and power recovery, if desired.

Saturation—the point at which a solution of a substance can dissolve no more of that substance. This point, the saturation point, depends on the temperature and pressure of the liquid, as well as, the chemical nature of the substances involved.

Terminal desalination module—the last desalination module on the transportation route.

Pretreatment for pipeline transportation occurs as or before inflow water is admitted to the transportation system. Pretreatment for desalination can be performed then, or within the pressurized pipeline, so any additional pretreatment can be deferred and tailored to a desalination method, in cases where more than one desalination method is located along a single pipeline. Additionally, pretreatment must be compatible with the use of the concentrate at the outflow(s). The inflow can be cooling water from an industrial facility, e.g., a power generation plant. These facilities usually require MF pre-treatment or the equivalent to protect the equipment from scaling and fouling.

### Features

1. Water transportation line

2. Reverse osmosis unit

3. Freshwater outflow

4. Pelton wheel

5. Electricity power

6. Low pressure concentrate outflow

7. High pressure warm saline water inflow

8. Pressure regulator

9. Optimum pressure warm saline water outflow

10. High pressure Concentrate outflow

11. High pressure pump

12. Reverse osmosis unit

13. Freshwater outflow

14. Water transportation line

15. Optimum pressure warm saline water outflow

16. Reverse osmosis unit

17. Freshwater outflow

18. High pressure Concentrate outflow

19. Pelton wheel

20. Low pressure concentrate outflow

21. Mechanical power

22. Power recovery—electric generator

23. Electricity power

24. Optimum pressure warm saline water outflow

25. Reverse osmosis unit

26. Freshwater outflow

29. High pressure Concentrate outflow

30. Pelton wheel

31. Low pressure concentrate outflow

32. Mechanical power

33. Power recovery—electric generator

34. Electricity power

35. Water transportation line

36. High pressure warm saline water inflow

37. Pressure regulator

38. Optimum pressure warm saline water outflow

39. Reverse osmosis unit

40. Freshwater outflow

41. High pressure Concentrate outflow

42. Pelton wheel

43. Low pressure concentrate outflow

44. Mechanical power

45. Power recovery—electric generator

46. Electricity power

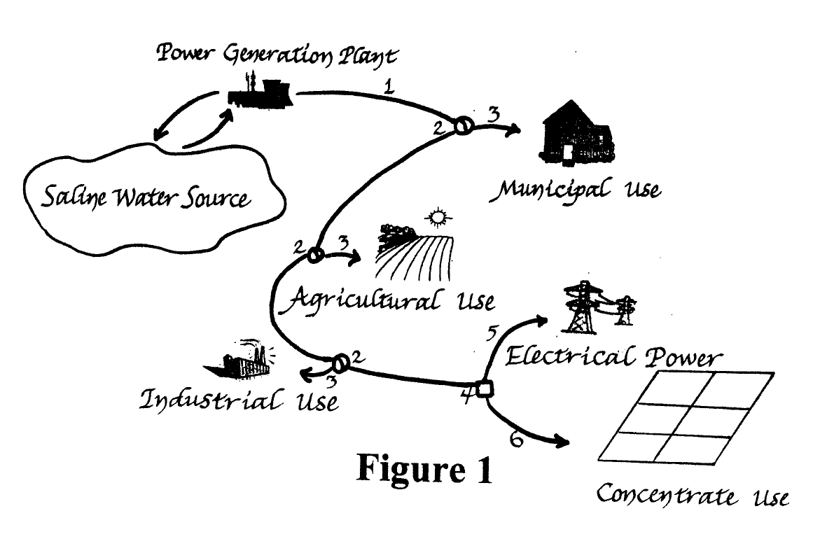

Referring to FIG. 1 showing a preferred embodiment, a power plant is located next to a saline body of water and uses the body of water as a source for the cooling water for the power plant. A part or all of the cooling water is diverted from it's normal disposition for use in the invention. Pretreatment for pipeline transportation occurs at this time. Pretreatment for desalination can be performed within the pressurized pipeline, so any additional pretreatment can be deferred and tailored to a desalination method, in cases where more than one desalination method is located along a single pipeline. Additionally, pretreatment must be compatible with the use of the concentrate at the outflow(s). The diverted cooling water goes through a high pressure pump 11 and is directed to a water transportation line 1 to deliver the high pressure warm saline water 7 to a distant site where the high pressure warm saline water 7 is used in a reverse osmosis 2 system to produce freshwater 3 and concentrate 10. The freshwater 3 can be of various quality standards depending on its intended use. The freshwater 3 could be used for drinking water or municipal water in communities, agriculture and farming or industrial and commercial. At the final destination, the high pressure warm saline water 7 is used to produce freshwater 3 and the concentrate 10, which is still at high pressure, is directed through a pelton wheel 4 to recover the energy (mechanical power 14) retained in the pressure. The concentrate 6, after the pelton wheel 4, is at a low pressure and available for the multitude of commercial uses for brine, one of which is salt production in evaporation ponds. The mechanical energy 14 extracted by the pelton wheel 4 is used to move an electric generator 15. The recovered electricity 5 can be used at the distant site for any available need, or sold.

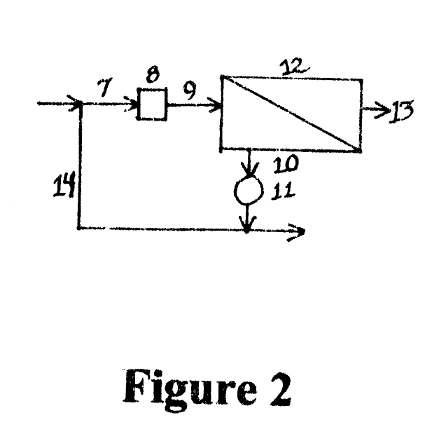

FIG. 2 shows a schematic of the various steps and products from an inline desalination module along the transport route according to one embodiment. A high pressure warm saline water inflow 7 comes off the water transportation line 14 and enters a pressure regulator 8 to lower the water pressure to a sufficient, preferably optimum, pressure for reverse osmosis unit 12. Optionally, a venture pump can be used to draw additional saline or contaminated water into the transportation system while simultaneously lowering the pressure to the optimum, perhaps assisted by a regulator. The pressurized warm saline water 9 enters the reverse osmosis unit 12 and produces a freshwater outflow 13 and a concentrate (brine) outflow 10. The concentrate outflow is still at high pressure, although it has lost some pressure during the reverse osmosis process. The concentrate outflow 10 goes to a high pressure pump 11 to return the concentrate to the same pressure as the water transportation pipe 14 and enters the water transportation pipe 14 to continue onto the final destination.

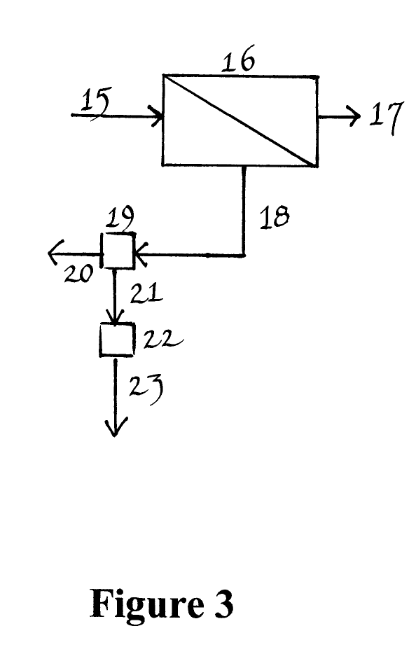

FIG. 3 shows a schematic of an embodiment of a single reverse osmosis system with power recovery which is a terminal desalination module. It produces both a freshwater outflow 17 and a low pressure concentrate outflow 20. The optimum pressure warm saline water inflow 15 enters the reverse osmosis unit 16. The reverse osmosis unit 16 produces a freshwater outflow 17 and high pressure concentrate outflow 18. The high pressure concentrate outflow 18 passes through a pelton wheel 19 to recover the energy in the high pressure concentrate 18 by producing a low pressure concentrate outflow 20. The mechanical energy 21 from the pelton wheel 19 is used to move an electric generator 22 to produce electricity 23.

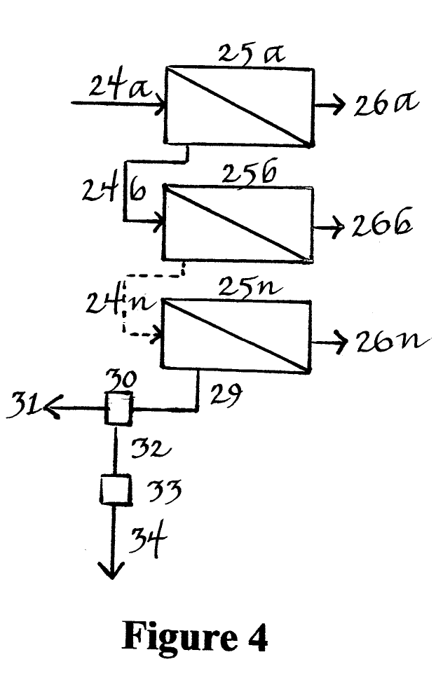

FIG. 4 shows a schematic of an embodiment of multiple reverse osmosis units in series along a transportation line. The optimum pressure warm saline water inflow 24a enters the first reverse osmosis unit 25a. The pressure may have been optimized by the use of a regulator and/or a venture pump, or the first reverse osmosis unit 25a may be designed to accept full transportation flow and pressure.

The optimum pressure saline water inflow 24a enters the first reverse osmosis unit 25a. The reverse osmosis unit 25a produces a freshwater outflow 26a and the optimum pressure inflow to the next stage 24b. The first reverse osmosis unit 25a does not extract the full quantity of freshwater 26. The concentrate outflow is transported to the next reverse osmosis unit 25n in series. This reverse osmosis unit extracts another quantity of freshwater 26n, which is still below the full amount. This process continues until the full amount of freshwater 26 has been extracted. The high pressure concentrate outflow 29 from the last reverse osmosis unit 25n in the series passes through a pelton wheel 30 to recover the energy in the high pressure concentrate 29 by producing a low pressure concentrate outflow 31. The mechanical energy 32 from the pelton wheel 30 is used to move an electric generator 33 to produce electricity 34.

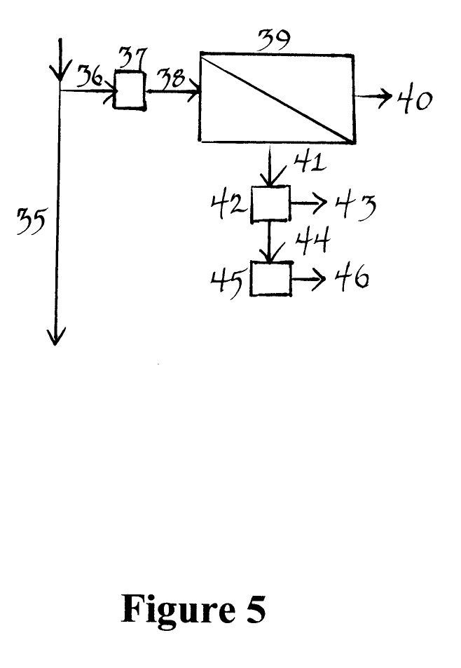

FIG. 5 shows a schematic of an embodiment of a reverse osmosis system where the freshwater outflow, low pressure concentrate and electricity is delivered to the same location, yet it is an inline desalination module. A high pressure warm saline water inflow 36 comes off the water transportation line 35 and enters a pressure regulator 37 to lower the water pressure to the optimum pressure for reverse osmosis unit 39. The optimum pressure warm saline water 38 enters to the reverse osmosis unit 39 and produces a freshwater outflow 40 and a high pressure concentrate (brine) outflow 41. The high pressure concentrate outflow 41 passes through a pelton wheel 42 to recover the energy in the high pressure concentrate 41 by producing a low pressure concentrate outflow 43. The mechanical energy 44 from the pelton wheel is used to move an electric generator 45 to produce electricity 46, which can be delivered for municipal, industrial, or agriculture uses.

The fact that the temperature of the cooling water has been increased above ambient (often around 90° F.) is extremely helpful, but not required for desalination. The use of the warm water effluent makes it economical, which otherwise would require enormous amounts of energy, to take advantage of the increased production obtained with large volume desalination.

Once the water has been warmed, given the pressures within the pipeline and the relatively small surface area ratio to product mass of a large diameter pipe, only moderate insulation is needed to limit thermal losses or gains during transport.

The Power used to pressurize the pipeline is ultimately recoverable. The recovery potential represents more than 100% of the total power requirement of a typical Reverse Osmosis module. Since most Reverse Osmosis units do not require more than 68 bars to operate and a pipeline is typically pressurized at 80 to 120 bars, the excess pressure (=power) is sold or scavenged. The power recovery can be done with a Pelton Wheel and a generator, or other power recovery technologies.

The pressure within the pipeline, in the range of 80 to 120 bars, exceeds the threshold needed for Reverse Osmosis/MF. The greater the pressure, the greater the potential flow rate and power content of the pipeline, the greater the potential fresh water recovery percentage, and the more flexibility in future adaptations for increasing or decreasing fresh and concentrate delivery requirements.

These factors enable the use of multiple Reverse Osmosis units powered primarily by pipeline pressure along the pipeline route, even given normal pressure losses due to hydraulic friction, possible elasticity of the pipeline, and the gains/losses attributable to changes in elevation. However, multiple desalination unit taps are not essential; it is possible to construct a single desalination unit anywhere along the pipeline route. Following any desalination unit, is possible to continue a concentrate-only pipeline retaining much of the original pressure to another destination, at which time power recovery may be applied as the concentrate is returned to near-ambient pressures. This permits delivery of fresh water and concentrate to diverse locations.

Reductions in the size of the pipeline following each desalination unit may be minimized by restricting the flow at key points along the pipeline route, such as immediately after a desalination unit. Data collection the length of the pipeline could enable automatic flow restriction mechanisms, and/or provide decision-making information for manual control. This permits near-uniform dimensions within the pipeline, retaining maximum future flexibility.

Pressure controls also allow taking Reverse Osmosis modules off-line for maintenance without shutting down upstream and downstream modules.

The cost savings of forgoing the flexibility of an over-all flow restriction mechanism and savings derived by reducing pipeline diameters must be weighed against the possibility of future demands that might outstrip the flexibility of a minimally-designed system, whose useful lifetime if typical of a high-pressure pipeline exceeds 25 years.

It may not be practical to return power generated by the energy recovery system directly to the high pressure pump at the pipeline head. Rather, the power may be phase-adjusted and fed into the local utility access point available to the final Reverse Osmosis unit, similar to a power generation windmill farm or grid-tied photovoltaic system. By selling the generated power to the local utility, the power consumed at the pipeline head is logically rather than physically offset. While it may not be the case that the same utility or generation mechanism is supplying power to both the head and tail of the pipeline, this is irrelevant if the entity managing the head of the pipeline is cooperative with or even the same entity that is managing the tail, so that the costs can be balanced.

Regarding the relative value of electricity at the head and tail, it is often the case that customer-generated power may be sold to the grid at rates that exceed the customers average use rate. Given these reasonable caveats, the net power consumption of the improved desalination process is greatly reduced by utilizing energy recovery, which is estimated to be on the order of 82 to 88% when using a Pelton wheel. Given hydraulic friction losses of 3% per Reverse Osmosis unit and estimating 12% for an arbitrary pipeline length, the over-all power consumption of the pressurization and pumping unit might be reduced by approximately 70%. It is to be expected that cost offsets will be at least commensurate.

The power consumption is reduced by pipelining saline water and generating fresh water locally as opposed to performing desalination at the head and pipelining fresh water to be delivered locally. The same pressurization that is used to charge the pipeline is used to provide most of the power to the Reverse Osmosis units on the line. The savings approaches 86% of the total power required for high-pressure pumping, since pipeline power is rarely recovered in the conventional method. Indeed, given that pipeline pressures exceed Reverse Osmosis requirements, it is possible that normal Reverse Osmosis unit power requirements will be completely absorbed by power recovery of the pipeline pressure.

Additional efficiency arises due to a side effect of introducing multiple Reverse Osmosis units in a single saline pipeline. No single unit is tapping a maximum amount of fresh water from the line, so that the flow through each Reverse Osmosis can be designed to be relatively high, on the order of ‘n’ times the extraction efficiency required at each unit. That is, assuming F is the total amount of water introduced to the new desalination process system; unit n actually requires just F/n of the total flow, if operating at maximum efficiency. Running a Reverse Osmosis module at maximum efficiency tends to increase maintenance requirements for the membranes and shorten their useful life. If, however, F is the flow through n, and the total amount of fresh water required is 1/n of max, the efficiency of unit n need only be 1/n of the theoretical maximum, and the extra flow will exert a scrubbing effect on the membranes. Conversely, we could use 1/n of the membrane surface area that might otherwise be used for a single Reverse Osmosis unit, which would also reduce the fresh water yield from the line. In the latter case, both the acquisition and maintenance costs of each Reverse Osmosis module are reduced to a factor of 1/n.

Variable flow restriction within the new desalination process system may address the issue of future expanded capacity economically. By operating with maximum flow restriction, the eventual capacity of the system can be increased within the range of a variable set of HP pumps coupled with the flow restriction mechanism, both of which are designed to operate within high and low capacity limits. Conversely, occasional replacement of the pumps need not necessitate replacement of either the pipeline or other elements of the new desalination process. It is thus possible to actually add or subtract capacity of existing individual Reverse Osmosis modules, to physically add modules to the pipeline, or even to adapt to a new desalination or pumping technology without modifying the overall desalination process.

Finally, the discharge of concentrate may be anywhere along the pipeline, assuming the final discharge follows the final (or sole) desalination unit. By waiting until a favorable location for power recovery, a geographically favorable location is insured to release the concentrate profitably. Gravity feed can be used to reduce the need for pumping the concentrate and fresh water product for industrial and farm uses by performing desalination at relatively high elevation.

In one embodiment, the temperature of the cooling water is raised about 10° C. above ambient. In another embodiment, the temperature of the cooling water is raised about 15° C. above ambient. In another embodiment, the temperature of the cooling water is raised >15° C. above ambient.

In one embodiment the temperature of the saline water in the pipe is around 40° C. In another embodiment the temperature of the saline water in the pipe is between 30° C. and 45° C.

In one embodiment the cooling water is pre-treated. In another embodiment the cooling water is treated with microfiltration. In another embodiment the cooling water is treated with an anti-scaling agent.

In one embodiment the concentrate industries are not established, and the concentrate and fresh water are sold at municipal rates with no premium.

In one embodiment the saline water is pre-treated with Acids. In one embodiment the saline water is pre-treated with hydrochloric acid. In one embodiment the saline water is pre-treated with sulfuric acid.

In one embodiment the saline water is pre-treated with Bases. In one embodiment the saline water is pre-treated with sodium hydroxide (NaOH). In one embodiment the saline water is pre-treated to ≧8 pH.

In one embodiment the saline water is pre-treated with dechlorination chemicals. In one embodiment the saline water is pre-treated with Sodium bisulfate.

In one embodiment the saline water is pre-treated with Anti-scalants. In one embodiment the saline water is pre-treated with Dispersants. In one embodiment the saline water is pre-treated with an anti-scalant or dispersant polymer.

In one embodiment the reverse osmosis module has a power recovery system using a Pelton Wheel. In one embodiment the reverse osmosis module is equipped with a high-pressure pump and a power recovery system using a Pelton Wheel.

In one embodiment the concentrate is used to produce salt. In one embodiment the concentrate reduces the area needed for salt production to approximately one sixth. In one embodiment the concentrate reduces the time needed for salt production to approximately one sixth.

In one embodiment the concentrate is sold as brine.

In one embodiment the concentrate is used to produce magnesium chloride. In one embodiment the concentrate is used to produce magnesium sulphate. In one embodiment the concentrate is used to produce potassium chloride. In one embodiment the concentrate is used to produce gypsum.

In one embodiment the Power Plant and the Reverse Osmosis unit are not located at the same facility. In one embodiment the Power Plant and the Reverse Osmosis unit are ≧0.5 miles a part. In one embodiment the Power Plant and the Reverse Osmosis unit are ≧1 mile a part. In one embodiment the Power Plant and the Reverse Osmosis unit are ≧2 miles a part. In one embodiment the Power Plant and the Reverse Osmosis unit are ≧3 miles a part. In one embodiment the Power Plant and the Reverse Osmosis unit are ≧4 miles a part. In one embodiment the Power Plant and the Reverse Osmosis unit are ≧5 miles a part. In one embodiment the Power Plant and the Reverse Osmosis unit are ≧10 miles a part. In one embodiment the Power Plant and the Reverse Osmosis unit are ≧15 miles a part. In one embodiment the Power Plant and the Reverse Osmosis unit are ≧20 miles a part. In one embodiment the Power Plant and the Reverse Osmosis unit are ≧25 miles a part. In one embodiment the Power Plant and the Reverse Osmosis unit are ≧50 miles a part. In one embodiment the Power Plant and the Reverse Osmosis unit are ≧75 miles a part. In one embodiment the Power Plant and the Reverse Osmosis unit are ≧100 miles a part. In one embodiment the Power Plant and the Reverse Osmosis unit are ≧125 miles a part. In one embodiment the Power Plant and the Reverse Osmosis unit are ≧150 miles a part. In one embodiment the Power Plant and the Reverse Osmosis unit are ≧200 miles a part.

In one embodiment there is one Reverse Osmosis unit between the Power Plant and the final production of concentrate. In one embodiment there are >1 Reverse Osmosis units between the Power Plant and the final production of concentrate. In one embodiment there are ≧2 Reverse Osmosis units between the Power Plant and the final production of concentrate. In one embodiment there are ≧3 Reverse Osmosis units between the Power Plant and the final production of concentrate. In one embodiment there are ≧4 Reverse Osmosis units between the Power Plant and the final production of concentrate. In one embodiment there are ≧5 Reverse Osmosis units between the Power Plant and the final production of concentrate. In one embodiment there are ≧10 Reverse Osmosis units between the Power Plant and the final production of concentrate. In one embodiment there are ≧15 Reverse Osmosis units between the Power Plant and the final production of concentrate. In one embodiment there are ≧25 Reverse Osmosis units between the Power Plant and the final production of concentrate. In one embodiment there are ≧50 Reverse Osmosis units between the Power Plant and the final production of concentrate.

### Cost Considerations

Cost is a dynamic and rapidly changing factor; however, the trend in Reverse Osmosis is declining costs. Reverse Osmosis technology produces fresh water to about $0.5 m³, or $616.74 per acre foot, approximately 2.5 times the current open market cost of municipal water in California. This trend alone, particularly given the contrasting increases in water costs from other sources in Southern California, could make conventionally-derived Reverse Osmosis water competitive with other sources within the decade. However, with this new desalination process we do not have to depend on future developments in order to make desalination reasonably competitive today; we have only to ensure power is distributed economically between Reverse Osmosis and transportation; that power recovery is implemented; and that we produce a product (concentrate or brine) that can be shown to be sufficiently valuable to offset the costs of desalination.

### EXAMPLE 1

A industrial plant is located on the shore of a saline or otherwise polluted body of water. The industrial plant can use type of fuel or method that produces heat for use during the power generating process. Water is pumped from the body of water and used during the cooling stage of the power generating process. During the cooling process, excess heat from the power generating process, is transferred to the body of water by conduction.

The heated water is transferred some distance from the industrial plant to a location in need of water for human consumption, agricultural or industrial use. The heated water is used in a method comprising the steps of:
1. obtaining water from a saline or otherwise polluted body of water
2. passing the water through a cooling system associate with an industrial plant to
3. raise the water temperature of the water above ambient
4. pressuring the heated water and transporting the water through a pipeline transportation system offsite from the industrial plant
5. taking a portion of the heated water, passing it through at least one offsite desalination system, generating usable water, and producing a hyper saline or otherwise contaminate-rich concentrate
6. optionally mixing the concentrate with the remaining heated water and transporting combined water to final destination
7. generating electrical power by reducing the pressure in pipe to ambient and recovering the power with a Pelton wheel or other power recovery technology
8. delivering concentrate for a commercial use to a final local.

### EXAMPLE 2

### Nuclear Cogeneration with an Improved Desalination

An industrial cogeneration power plant with two units is located on the shore next to a saline water source. Each unit has a 32% efficiency, which means that 68% of the generated heat is lost to the cooling water. The two units combined generate 6,600 MWt which produces 2,200 MWe. Thus, 4,400 MWth is lost to the cooling water. The amount of cooling water flowing through the Cooling Water system of each reactor unit is about 1.2 Billion gals, or a total of 2.4 Billion per day. The total Cooling Water discharge per year is about 2.7 Million acre-feet.

The water is discharged from the Cooling Water system at a temperature around 90° F. This temperature is very near the optimal pre-heating temperature for the Reverse Osmosis desalination modules.

The large flow of pre-treated, heated water from the cooling water system is pressurized and transported down the pipeline. The imparted pressure is retained, and thermal coupling adjustments are implemented to slightly reduce the flow but increase the heat of the outflow when pipeline(s) handle the entire outflow.

The Cooling Water system has a bypass mechanism, which is usually closed, to shunt the water back into the saline body of water in case the pipeline(s) are shut down and the water is re-routed back through the diffusers.

The pressure of the Cooling Water system is coupled with an additional high-pressure pump to increase the water up to at least the pressure required by a high-pressure pipeline. The heated treated water is transported by an insulated, high-pressure pipeline to an inland destination.

The pressure from the pipeline is used to power the desalination plant(s) along the route and/or at the pipeline terminus. Fresh water is extracted and allowed to flow into a water treatment plant for calcification and other post-treatment. Post-treatment varies depending on the intended use of the fresh water.

The concentrate exits the Reverse Osmosis unit, still at high pressure, and is used to power a Pelton wheel, whose rotational torque is used to power a generator. The concentrate returns to near-ambient pressure, and flows downhill or is pumped to industrial and farm consumers where it is economical to use. The output of the generator is sold to the local utility company as excess power or returned to the pumping station, offsetting the cost of the power consumed by the high-pressure pump at the pipeline head.

The locations of the Pelton wheels and concentrate outflow delivery, as well as fresh water delivery, are selected to permit gravity distribution where possible and easy access to the electrical grid. The Pelton wheel, concentrate outflow, and the desalination facility are co-located, but this is not a requirement.

The presence of power, fresh water product, and concentrate promotes the establishment of local industries which consume the concentrate. These industries will invigorate rail heads, trucking companies, supply companies and other infrastructure enhancements.

Additionally, Inland community development and expansion is enabled by the presence of additional water and power.

Another advantage is a virtually unlimited source of saline water along the pipeline route for firefighting, saline pools and saline landscaping, as well as, additional Reverse Osmosis modules. Branch outlets are present to route feeder pipe lines or open transport mechanisms for any of these purposes.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, machine, means, methods and/or steps described in the specification. As one of ordinary skill in the art will readily appreciate from the disclosure of the present invention, processes, machines, means, methods, or steps, presently existing or later to be developed that perform substantially the same function or achieve substantially the same result as the corresponding embodiments described herein may be utilized according to the present invention. Accordingly, the invention is intended to include within its scope such processes, machines, means, methods, or steps.

What is claimed is:

1. A method of producing desalinated water, comprising the steps of:
obtaining saline water,
passing the saline water through a cooling system associated with a power plant, thereby raising the temperature of the saline water above ambient,
pressurizing the heated saline water,
transporting the pressurized heated saline water from the power plant through a water transportation line, and
delivering the pressurized heated saline water to an offsite location of at least one desalination system to produce desalinated water.

2. The method of claim 1, further comprising the steps of:
taking the heated saline water from the water transportation line, and
passing the heated saline water through the at least one desalination system, thereby producing freshwater and a hypersaline concentrate.

3. The method of claim 2, further comprising the steps of:
returning the hypersaline concentrate to the water transportation line,
transporting the pressurized heated saline water to a final destination,
passing the pressurized heated saline water through the at least one desalination system, and
producing freshwater and a hypersaline concentrate.

4. The method of claim 2, further comprising the steps of:
directing the hypersaline concentrate through at least one Pelton wheel, thereby generating electricity, and
delivering the concentrate to a final destination for commercial use.

5. The method of claim 3, further comprising the steps of:
directing the hypersaline concentrate through at least one Pelton wheel, thereby generating electricity, and
delivering the concentrate to a final destination for commercial use.

6. The method of claim 1, where the offsite location of the at least one desalination system is different from the power plant site.

7. The method of claim 6, where the offsite location of the at least one desalination system is greater than 0.5 miles from the power plant site.

8. The method of claim 7, where the offsite location of the at least one desalination system is greater than 1 miles from the power plant site.

9. The method of claim 8, where the offsite location of the at least one desalination system is greater than 25 miles from the power plant site.

10. The method of claim 9, where the offsite location of the at least one desalination system is greater than 50 miles from the power plant site.

11. The method of claim 10, where the offsite location of the at least one desalination system is greater than 100 miles from the power plant site.

12. The method of claim 2, where the at least one desalination system is connected in parallel with at least one other desalination system.

13. The method of claim 2, where the at least one desalination system is connected in series with at least one other desalination system.

14. The method of claim 2, where the freshwater is selected from the group consisting of agricultural water, industrial water, municipal water and human consumption water.

15. The method of claim 2, where a commercial use of the concentrate is selected from the group consisting of salt production, chemical extraction, agricultural, and industrial use.

16. A method for providing freshwater and concentrate comprising:
obtaining a saline water source,
using an offsite desalination system to obtain freshwater and concentrate, and
delivering the concentrate to a user of the concentrate in exchange for a service fee.

17. The method for providing freshwater and concentrate of claim 16, further comprising:
sending the concentrate through a Pelton wheel, thereby generating electricity, and
delivering the electricity to a user of the electricity in exchange for a service fee.

18. The method for providing freshwater and concentrate of claim 16, further comprising:
sending the concentrate through a Pelton wheel, thereby generating electricity, and
delivering the electricity to an electrical power exchange or directly into an electrical grid in exchange for a service fee.

19. The method for providing freshwater and concentrate of claim 16, further comprising:
delivering the freshwater to a user of the freshwater in exchange for a service fee.

20. A method of producing desalinated water, comprising the steps of:
obtaining saline water from a saline body of water,
raising the temperature of the saline water above ambient,
pressurizing the heated saline water,
transporting the pressurized heated saline water from a power plant through a water transportation line, and
delivering the pressurized heated saline water to an offsite location of at least one desalination system to produce desalinated water.
